(19) United States
(12) Patent Application Publication
(10) Pub. No.: US 2026/0109060 A1
(43) Pub. Date: Apr. 23, 2026

(54) MULTIFUNCTIONAL TOOL CHUCK

(71) Applicant: TOOLSLAND INVENT CO., LTD., Shanghai (CN)

(72) Inventor: Janie YOU, Shanghai (CN)

(73) Assignee: TOOLSLAND INVENT CO., LTD., Shanghai (CN)

(21) Appl. No.: 19/148,271

(22) PCT Filed: Mar. 17, 2025
(86) PCT No.: PCT/CN2025/082944

§ 371 Date: Jul. 15, 2025

(30) Foreign Application Priority Data
Apr. 10, 2024 (CN) 202420735110.1

(51) Int. Cl. B26B 5/00

(52) U.S. Cl. CPC B26B 5/00

(57) ABSTRACT

The invention discloses a multifunctional tool chuck which comprises a fixing head, a fixing piece, a fixing pin and a spring, the fixing head is fixedly arranged, and a polygonal hole position for inserting a multifunctional tool head is formed in the end face of the fixing head; the fixing piece is arranged around the fixing head, one end of the fixing piece is rotatably connected with the fixing head, and a mounting hole is formed in the fixing piece; a sliding groove is formed in a side plate of the fixing head, and the fixing pin penetrates through the sliding groove and the mounting hole; the spring is arranged at one end of the fixing piece and is connected with the fixing piece.

### CROSS-REFERENCE TO RELATED APPLICATIONS

This application claims priority from PCT Ser. No. PCT/CN2025/082944 filed Mar. 17, 2025, the entire contents of which are incorporated herein by reference, which in turn claims priority from Chinese Ser. No.: 202420735110.1 filed Apr. 10, 2024.

### FIGURE SELECTED FOR PUBLICATION

FIG. 1.

### BACKGROUND OF THE INVENTION

### Field of the Invention

The invention relates to the technical field of multifunctional tools, in particular to a multifunctional tool chuck.

### Description of the Related Art

Current tool chucks are widely used. In terms of technical aspects of multifunctional tool chucks, the main features include the following:
material, they are typically made of stainless steel or aluminum alloy to achieve lightweight and corrosion-resistant properties;
clamping mechanism, they employ quick-release clamps or twist-type clamps to enable rapid and reliable fixation of pen-shaped devices and workpieces of various shapes;
function, depending on the product, they are equipped with different functional components such as blades, pliers, and hammers to meet diverse engineering operation needs;
design, various functional components are compactly integrated, resulting in a small, portable, and user-friendly form factor;
pricing, due to their compact and portable characteristics, multifunctional tool chucks are highly practical and relatively low-cost, making them suitable for daily production and property maintenance applications.

The existing solutions present the following issues: material and processing technology limitations restrict further miniaturization and complex shaping, constraining usage flexibility; the quantity and variety of functional components are limited, making it difficult to cover all operational scenarios; structural designs struggle to maintain stable fixation of workpieces with varying sizes and shapes over extended periods; replacement of individual damaged functional components is inconvenient, necessitating more accessible replacement designs; service life is significantly affected by working environment and frequency, requiring enhanced material and structural strength; pricing remains relatively uniform, making it challenging to implement differentiated pricing based on varying functions and specifications to meet diverse customer needs.

### SUMMARY OF THE INVENTION

In view of this, the objective of the invention is to provide a multifunctional tool chuck.

To achieve the above objective, the technical solution adopted by the invention is as follows:

A multifunctional tool chuck, comprising:
a fixing head, the fixing head is fixedly arranged, and a polygonal hole position for inserting a multifunctional tool head is formed in the end face of the fixing head;
a fixing piece, the fixing piece is arranged around the fixing head, one end of the fixing piece is rotatably connected with the fixing head, and a mounting hole is formed in the fixing piece;
a fixing pin, a sliding groove is formed in a side plate of the fixing head, and the fixing pin penetrates through the sliding groove and the mounting hole;
a spring, the spring is arranged at one end of the fixing piece and is connected with the fixing piece.

The above mentioned multifunctional tool chuck, wherein two ends of the fixing pin protrude from side surfaces of two ends of the fixed head.

The above mentioned multifunctional tool chuck, wherein the fixing pin moves within the sliding groove, and the fixing pin fixes the fixed head in a relative position to the fixing piece.

The above mentioned multifunctional tool chuck, wherein the sliding groove communicates with the polygonal hole position, and the sliding groove controls a size of the polygonal hole position.

The above mentioned multifunctional tool chuck, wherein the multifunctional tool chuck is connected with a handle, the handle is provided with a fixing hole, and a portion of the multifunctional tool chuck extends into the fixing hole.

The above mentioned multifunctional tool chuck, wherein the polygonal hole position is provided with an inclined surface, and the inclined surface has the same angle of inclination as that of the sliding groove.

The above mentioned multifunctional tool chuck, wherein the polygonal hole position comprises a plurality of inner wall surfaces, and the plurality of inner wall surfaces are perpendicular to the end surface of the fixed head.

The above mentioned multifunctional tool chuck, wherein the handle is provided with a through hole, one end of the fixed head is provided with a through hole corresponding to the through hole of the handle, and a screw penetrates the through holes and fixes the handle in a relative position to the fixed head.

The above mentioned multifunctional tool chuck, wherein the mounting hole is provided with an inclined surface, and the fixing pin moves along a length direction of the mounting hole.

The above mentioned multifunctional tool chuck, wherein the fixing piece is C-shaped, a middle portion of the fixing piece forms a groove for accommodating the fixed head, a rotating shaft is horizontally arranged on one side of the fixed head, and the fixing piece is rotatably connected with the fixed head through the rotating shaft.

The invention, by employing the aforementioned technology, achieves the following advantageous effects compared with prior art:
(1) According to the invention, the fixing pins are adopted to fix a plurality of multifunctional tool knives with different models, so that the cost for replacing tool heads is reduced, and the use efficiency is improved.
(2) According to the utility modelinvention, the fixing sheet and the fixing head are adopted, so that smaller size and more complex shape can be realized, and the use flexibility is higher.

### BRIEF DESCRIPTION OF THE DRAWINGS

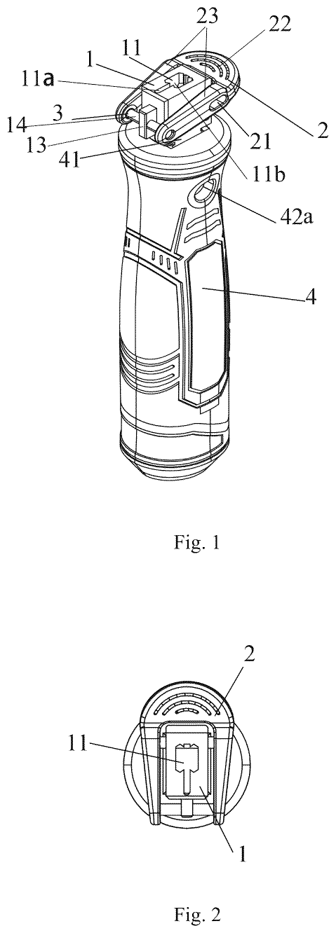

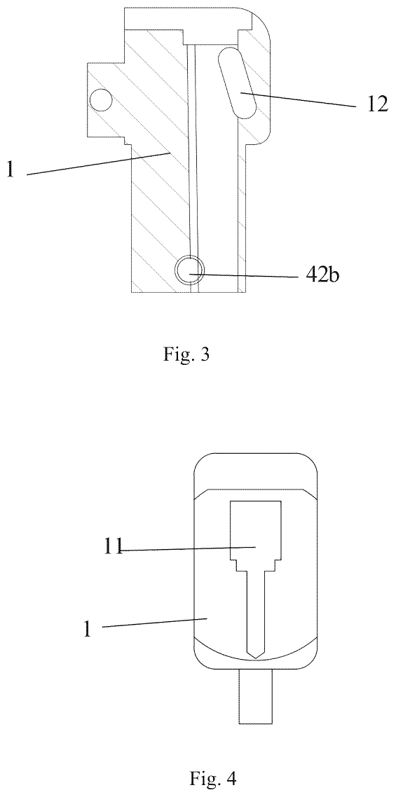

FIG. 1 is a schematic isometric view of the multifunctional tool chuck according to the invention.

FIG. 2 is a schematic top view of the multifunctional tool chuck according to the invention.

FIG. 3 is a schematic left-side view of the fixed head of the multifunctional tool chuck according to the invention.

FIG. 4 is a schematic top view of the fixed head of the multifunctional tool chuck according to the invention.

In the drawings: 1. fixed head; 11. polygonal hole position; 12. sliding groove; 13. rotating shaft base; 14. rotating shaft; 2. fixing piece; 21. mounting hole; 22. hand-held portion; 23. arm, 3. spring; 4. handle; 41. fixing hole; 42. through hole.

### DETAILED DESCRIPTION

The invention is further described below with reference to the accompanying drawings and specific embodiments, without limiting its scope. FIG. 1 is a schematic isometric view of the multifunctional tool chuck according to the invention; FIG. 2 is a schematic top view of the multifunctional tool chuck according to the invention; FIG. 3 is a schematic left-side view of the fixed head of the multifunctional tool chuck according to the invention; FIG. 4 is a schematic top view of the fixed head of the multifunctional tool chuck according to the invention. Referring to FIGS. 1 to 4, there is provided a preferred embodiment of the multifunctional tool chuck, comprising: a fixed head 1, a fixing piece 2, a fixing pin, and a spring 3, the fixing head 1 is fixedly arranged, and a polygonal hole position 11 for inserting a multifunctional tool head is formed in the end face of the fixing head; the fixing piece 2 is arranged around the fixing head 1, one end of the fixing piece 2 is rotatably connected with the fixing head 1, and a mounting hole 21 is formed in the fixing piece; a sliding groove 12 is formed in a side plate of the fixing head 1, and the fixing pin penetrates through the sliding groove 12 and the mounting hole 21; the spring 3 is arranged at one end of the fixing piece 2 and is connected with the fixing piece 2.

Specifically, the fixing piece 2 is C-shaped, a middle portion of the fixing piece 2 forms a groove for accommodating the fixed head 1.

Specifically, a rotating shaft is horizontally arranged on one side of the fixed head 1, and the fixing piece 2 is rotatably connected with the fixed head 1 through the rotating shaft.

More specifically, the side surface of the fixed head 1 extends outward to form a rotating shaft base 13, on which a rotating shaft 14 is horizontally arranged, and the rotating shaft 14 is rotatably connected with the rotating shaft base 13.

More specifically, the fixing piece 2 comprises a hand-held portion 22 and two arms 23 extending outward from two ends of the hand-held portion 22, the hand-held portion 22 and two arms 23 form a C-shape. The two arms 23 are fixedly connected with two ends of the rotating shaft 14, so as to allow the fixing piece 2 to rotate about the axis of the rotating shaft 14.

More specifically, as shown in FIG. 1, the fixing piece 2 can rotate to the left side to disengage its outer periphery from the fixed head 1, and can also rotate to the right side to position the fixed head 1 within its groove.

In a preferred embodiment, two ends of the fixing pin protrude from side surfaces of two ends of the fixed head 1.

In a preferred embodiment, the fixing pin moves within the sliding groove 12, and the fixing pin fixes the fixed head 1 in a relative position to the fixing piece 2.

In a preferred embodiment, the sliding groove 12 communicates with the polygonal hole position 11, and the sliding groove 12 controls a size of the polygonal hole position 11.

In a preferred embodiment, the polygonal hole position 11 comprises: a first portion 11a formed on the surface of the fixed head 1, and a second portion 11b formed along the axial direction of the fixed head 1 and communicating with the first portion 11a.

The sliding groove 12 communicates with the second portion 11b and is arranged obliquely relative to the second portion 11b.

Specifically, when the fixing pin approaches the first portion 11a, the inner diameter of the polygonal hole position 11 decreases to secure a small-diameter multifunctional tool head; when the fixing pin moves away from the first portion 11a, the inner diameter of the polygonal hole position 11 increases to secure a large-diameter multifunctional tool head.

In a preferred embodiment, the multifunctional tool chuck is connected with a handle 4, the handle 4 is provided with a fixing hole 41, and a portion of the multifunctional tool chuck extends into the fixing hole 41.

In a preferred embodiment, the polygonal hole position 11 is provided with an inclined surface, and the inclined surface has the same angle of inclination as that of the sliding groove 12.

In a preferred embodiment, the polygonal hole position 11 comprises a plurality of inner wall surfaces, and the plurality of inner wall surfaces are perpendicular to the end surface of the fixed head 1.

Preferably, the first portion 11a of the polygonal hole position has a T-shape, with the portion adjacent to the sliding groove 12 forming the top of the T-shape.

The above describes only preferred embodiments of the invention, which therefore do not limit the implementation methods or scope of protection of the invention.

The invention further includes the following embodiments based on the above:

In a further embodiment of the invention, the handle is provided with a through hole 42a, one end of the fixed head is provided with a through hole 42b corresponding to the through hole 42a of the handle, and a screw penetrates the through hole 42a and the through hole 42b and fixes the handle 4 in a relative position to the fixed head 1.

In a further embodiment of the invention, the mounting hole 21 is provided with an inclined surface, and the fixing pin moves along a length direction of the mounting hole 21. Specifically, the fixing pin and the spring engage with the multifunctional tool head for operation.

The foregoing describes only preferred embodiments of the invention, which therefore do not limit its embodiments or scope of protection. Those skilled in the art should recognize that all solutions obtained through equivalent substitutions or obvious modifications based on the specification and drawings of this invention shall fall within its protective scope.

1. A multifunctional tool chuck, comprising:
a fixing head, the fixing head is fixedly arranged, and a polygonal hole position for inserting a multifunctional tool head is formed in the end face of the fixing head;
a fixing piece, the fixing piece is arranged around the fixing head, one end of the fixing piece is rotatably connected with the fixing head, and a mounting hole is formed in the fixing piece;
a fixing pin, a sliding groove is formed in a side plate of the fixing head, and the fixing pin penetrates through the sliding groove and the mounting hole;
a spring, the spring is arranged at one end of the fixing piece and is connected with the fixing piece.

2. The multifunctional tool chuck according to claim 1, wherein two ends of the fixing pin protrude from side surfaces of two ends of the fixed head.

3. The multifunctional tool chuck of claim 1, wherein the fixing pin moves within the sliding groove, and the fixing pin fixes the fixed head in a relative position to the fixing piece.

4. The multifunctional tool chuck of claim 1, wherein the sliding groove communicates with the polygonal hole position, and the sliding groove controls a size of the polygonal hole position.

5. The multifunctional tool chuck of claim 1, wherein the multifunctional tool chuck is connected with a handle, the handle is provided with a fixing hole, and a portion of the multifunctional tool chuck extends into the fixing hole.

6. The multifunctional tool chuck of claim 1, wherein the polygonal hole position is provided with an inclined surface, and the inclined surface has the same angle of inclination as that of the sliding groove.

7. The multifunctional tool chuck of claim 1, wherein the polygonal hole position comprises a plurality of inner wall surfaces, and the plurality of inner wall surfaces are perpendicular to the end surface of the fixed head.

8. The multifunctional tool chuck of claim 5, wherein the handle is provided with a through hole, one end of the fixed head is provided with a through hole corresponding to the through hole of the handle, and a screw penetrates the through holes and fixes the handle in a relative position to the fixed head.

9. The multifunctional tool chuck of claim 1, wherein the mounting hole is provided with an inclined surface, and the fixing pin moves along a length direction of the mounting hole.

10. The multifunctional tool chuck of claim 1, wherein the fixing piece is C-shaped, a middle portion of the fixing piece forms a groove for accommodating the fixed head, a rotating shaft is horizontally arranged on one side of the fixed head, and the fixing piece is rotatably connected with the fixed head through the rotating shaft.
